(19) United States
(12) Patent Application Publication
(10) Pub. No.: US 2007/0278198 A1
(43) Pub. Date: Dec. 6, 2007

(54) Welding System

(75) Inventors: Yoshitaka Aoyama, Osaka (JP); Shoji Aoyama, Osaka (JP)

Correspondence Address: Roylance Abrams Berdo and Goodman, Suite 600, 1300 19th Street N W, Washington, DC, 20036-1649, US

(73) Assignee: DAIMLERCHRYLSER AG, STUTTGART GERMANY (DE)

(21) Appl. No.: 10/587,540

(22) PCT Filed: Feb. 8, 2005
(86) PCT No.: PCT/JP05/01800

§ 371 Date: Jun. 4, 2007

(30) Foreign Application Priority Data
Feb. 14, 2004 (JP) 2004-071685

(51) Int. Cl. B23K 9/24; B23K 37/02

(52) U.S. Cl. 219/136; 219/161

(57) ABSTRACT

A welding device (66) in which a movable electrode (6) is attached to moving drive means (68), the movable electrode (6) and a fixed electrode (8) forming a pair, and a part feeding device (82, 8) for feeding a part (10) to a target position by a feeding rod (2, 87) moving forward and backward are integrated through a coupling member (79, 91, 90, 94), so that an end position of the feeding rod (2, 87) moved forward and an end portion of the movable electrode 6 are in a predetermined relative positional relation. Therefore, it is possible to precisely obtain the relative position between the electrode of the welding device and an end portion of the feeding rod of the part feeding device moved forward.

### TECHNICAL FIELD

The present invention relates to a welding system which comprises a combination of a welding device and a part feeding device.

### BACKGROUND ART

By combining a part feeding device for feeding a part to a target position by use of a feeding rod moving forward and backward with a welding device having a fixed electrode and a movable electrode, a projection bolt or a projection nut is welded to a steel plate member.

In such a combination of a part feeding device and a welding device, a part such as the projection bolt is precisely provided in a predetermined position of a target member such as a steel plate member set on a welding device to carry out electric resistance welding (see Japanese Patent Laid-Open Publication No. Hei 7-276061).

In the foregoing combination of a part feeding device and a welding device, it is necessary to precisely set the relative position between an end position of the feeding rod of the part feeding device moved forward and the predetermined position of the steel plate member or the like set on the welding device. Especially, it is extremely difficult to set the foregoing relative position with fine adjustment at the site of a plant due to local limitations and the like. Thus, there are cases where it becomes difficult to precisely obtain the foregoing relative position. Furthermore, since a position in which the part feeding device is disposed cannot be flexibly changed, the steel plate member or the like set on the welding device may interfere with the part feeding device, another adjacent device, or the like. To prevent interference, restrictions occur on the size and shape of the steel plate member and the like. As a result, productivity is not sufficiently improved.

### DISCLOSURE OF THE INVENTION

In a welding system according to an embodiment of the present invention, a welding device in which a movable electrode is attached to moving drive means, the movable electrode and a fixed electrode forming a pair, and a part feeding device for feeding a part to a target position by a feeding rod moving forward and backward are integrated through a coupling member, so that an end position of the feeding rod moved forward and an end portion of the movable electrode or the fixed electrode are in a predetermined relative positional relation.

Since they are integrated through the coupling member so that the end position of the feeding rod moved forward and the end portion of the movable electrode or the fixed electrode are in the predetermined relative positional relation, the end position of the feeding rod moved forward and the end portion of the movable electrode or the fixed electrode satisfy the predetermined relative positional relation by properly setting the shape, the size, and the like of the coupling member. Namely, selecting the shape, the size, and the like of the coupling member makes it possible to properly set the relative position between the end position of the feeding rod and the end portion of the movable electrode or the fixed electrode, at the same time when integrating the welding device with the part feeding device through the coupling member. Accordingly, the relative position is correctly set in advance in manufacturing the welding system, so that it is possible to prevent difficult operation by which the relative position between the part feeding device and the welding device is set in a tight place after the part feeding device is brought in a plant. Since the welding system is completed in advance, the relative position between the welding device and the part feeding device can be set with high precision by use of a jig or the like. Therefore, it is possible to provide the welding system with high quality for a customer.

When a fixing member for fixing the welding device on a stationary member is provided, the welding device and the part feeding device, which are integrated through the coupling device, is unitedly fixed on the stationary member. Accordingly, only the welding device is coupled to the stationary member and any external force is not applied to the part feeding device, the predetermined relative positional relation between the end position of the feeding rod moved forward and the end outline of the movable electrode or the fixed electrode is not misaligned. Therefore, it is possible to always carry out normal part feeding and welding.

The fixing member comprises a member main body and a fixed shaft member, which are integrated with each other. The member main body is coupled to an end portion of the moving drive means. The fixed shaft member is coupled to the stationary member to fix the welding system on the stationary member. An axis line of the fixed shaft member is approximately coaxial with a moving axis line of the movable electrode. When a rotational position of the welding system is selectively set by rotating the member main body with respect to the fixed shaft member, the fixing member coupled to the end portion of the moving drive means fixes the welding system on the stationary member as described above. At the same time, the rotational position of the whole welding system can be flexibly set by the fixed shaft member, which is approximately coaxial with the moving axis line of the movable electrode. Thus, it is possible to optimize the attachment position of the welding system in accordance with the size and the shape of an adjacent device or a target part such as the steel plate member.

When the coupling member is integrated with the fixing member, the coupling member being a member for supporting the part feeding device is integrated with the fixing member. Thus, it is possible to increase the coupling rigidity of the coupling member, and hence the coupling stability of the part feeding device is improved. Since the fixing member is integrated with the coupling member, it is possible to simplify the structure of a foundation member for attaching the part feeding device and the welding device to the stationary member. Therefore, the whole welding system becomes compact.

When a plurality of part feeding devices each of which feeds a different type of part are attached to the coupling member or an auxiliary member integrated with the coupling member, the welding system functions as a welding unit of a projection nut, concurrently with functioning as a welding unit of a projection bolt, and hence it is possible to make the welding system multifunctional. It is also possible to reduce space necessary for disposing the equipment, and costs for the equipment.

When the foregoing part is a projection bolt with a flange which is provided with a projection for welding and/or a projection nut provided with a projection for welding, it is possible to freely select the projection bolt and/or projection nut and weld it. Thus, it is possible to obtain the welding system with high utility.

A support rod attached to the part feeding device extends approximately in a vertical direction. When the support rod penetrates a clamp block fixed on the stationary member and the clamp block clamps and loosens the outer periphery of the support rod to set the vertical position of the support rod, an auxiliary clamp block for setting a moving distance of the support rod in advance may be disposed over and/or under the clamp block in such a manner that the auxiliary clamp block penetrates the support rod.

When the part feeding device is moved down, the clamp block is clamped at first. Then, the auxiliary clamp block over the clamp block is loosened, and moved up by a distance corresponding to a distance to be moved down. Then, the auxiliary clamp block is tightly clamped again on the support rod. After that, the clamp block is loosened. Thus, the support rod is moved down by a mass of the part feeding device. The auxiliary clamp block is caught by the top face of the clamp block in a stationary state, so that the move-down position of the part feeding device is set. The clamp block is clamped at the last, so that move-down operation is completed. As described above, it is possible to set the amount of moving down the part feeding device only by moving the auxiliary clamp block upward in advance by a predetermined distance. Furthermore, the support rod is moved down by its own weight of the part feeding device, and the auxiliary clamp block functions as a stopper, so that the lower limit position of move-down is set. Accordingly, it is possible to precisely set the amount of move-down with easy operation. Furthermore, the operation is simplified and becomes safe. When the auxiliary clamp block is also disposed under the clamp block, the auxiliary clamp block is moved up after the completion of the move-down operation. Then, the auxiliary clamp block is made tightly contact with the bottom face of the clamp block, and is clamped on the support rod.

When the part feeding device is moved up, on the other hand, the clamp block is clamped at first. Then, the auxiliary clamp block under the clamp block is loosened and moved down by a distance, which corresponds to a distance to be moved up. Then, the auxiliary clamp block is tightly clamped again on the support rod. After that, since the clamp block is loosened and the part feeding device is lifted up, the support rod is moved up. The auxiliary clamp block is caught by the bottom face of the clamp block in the stationary state, so that the vertical position of the part feeding device is set. The clamp block is clamped at the last, so that move-up operation is completed. As described above, the amount of moving up the part feeding device can be set only by moving down the auxiliary clamp block by a predetermined distance in advance. Furthermore, the support rod can be moved up only by lifting the part feeding device. The auxiliary clamp block functions as a stopper, so that the upper limit position of move-up is set. Accordingly, it is possible to precisely set an amount of move-up with easy operation. Furthermore, the operation is simplified and becomes safe. When the auxiliary clamp block is also disposed over the clamp block, the auxiliary clamp block is moved down after the completion of the move-up operation. Then, the auxiliary clamp block is made tightly contact with the top face of the clamp block, and is clamped on the support rod.

The clamp block has a penetration hole through which the support rod with a circular cross section penetrates, a slit section continued from the penetration hole, and a fixing bolt penetrating the slit section. According to this structure, the support rod in the shape of the circle in cross section penetrates through the penetration hole of the clamp block, and the clamp block is clamped and loosened with the fixing bolt. Therefore, it is possible to smoothly move and certainly fix the support rod.

The auxiliary clamp block has a penetration hole through which the support rod penetrates, a slit section continued from the penetration hole, and a fixing bolt penetrating the slit section. An end face of the auxiliary clamp block can abut to an end face of the clamp block. The structure of the auxiliary clamp block itself is similar to that of the clamp block. According to the auxiliary clamp block with such a structure, it is possible to easily and certainly obtain the proper position of the auxiliary clamp block by clamping and loosening the auxiliary clamp block on the support rod, and hence it is possible to precisely carry out the move-down and move-up operations of the part feeding device.

The part feeding device feeds a part held by the feeding rod to the fixed electrode or the movable electrode of the welding device, in order to weld the part fed between the fixed electrode and the movable electrode by the feeding rod to the target part. To move the feeding rod ahead between the fixed electrode and the movable electrode, and certainly feed a part such as a projection bolt to the fixed electrode or the movable electrode for holding, the relative position between the part feeding device and the welding device has to be pursued with high precision. Since the positioning of the part feeding device is carried out by a combination of the auxiliary clamp block and the clamp block as described above, the problem of precision can be easily solved.

### BRIEF DESCRIPTION OF THE DRAWINGS

FIG. 1 is a side view of the whole welding system according to a first embodiment;

FIG. 2 is a plan view showing the portion of a support arm;

FIG. 3 is a plan view of a coupling member and a fixing member;

FIG. 4 is a perspective view of the coupling member and the fixing member;

FIG. 5 is a plan view of a plurality of part feeding devices according to a second embodiment;

FIG. 6 is a perspective view of another part feeding device;

FIG. 7 is a side view showing the positional relation between a plurality of types of feeding rods and an electrode;

FIG. 8 is a front view of a fixing arm;

FIG. 9 is a side view of a part feeding device;

FIG. 10 is a side view of a projection bolt;

FIG. 11 is a perspective view of a base plate by itself;

FIG. 12 is a sectional view taken along the line (12)-(12) of FIG. 9;

FIG. 13 is a side view showing an end portion of a guide tube without the base plate;

FIG. 14 is a sectional view of a part feeding control unit;

FIG. 15 is a plan view of the end portion of the guide tube;

FIG. 16 is a plan view of the end portion of the guide tube;

FIG. 17 is a sectional view taken along the line (17)-(17) of FIG. 13;

FIG. 18 is a perspective view showing the whole structure of the part feeding device;

FIG. 19 is a partly broken plan view of a clamp block;

FIG. 20 is a partly broken plan view of the clamp block;

FIG. 21 is a perspective view of an auxiliary clamp block;

FIG. 22 is a drawing showing the process of move-down operation of the part feeding device; and

FIG. 23 is a drawing showing the process of move-up operation of the part feeding device.

### BEST MODE FOR CARRYING OUT THE INVENTION

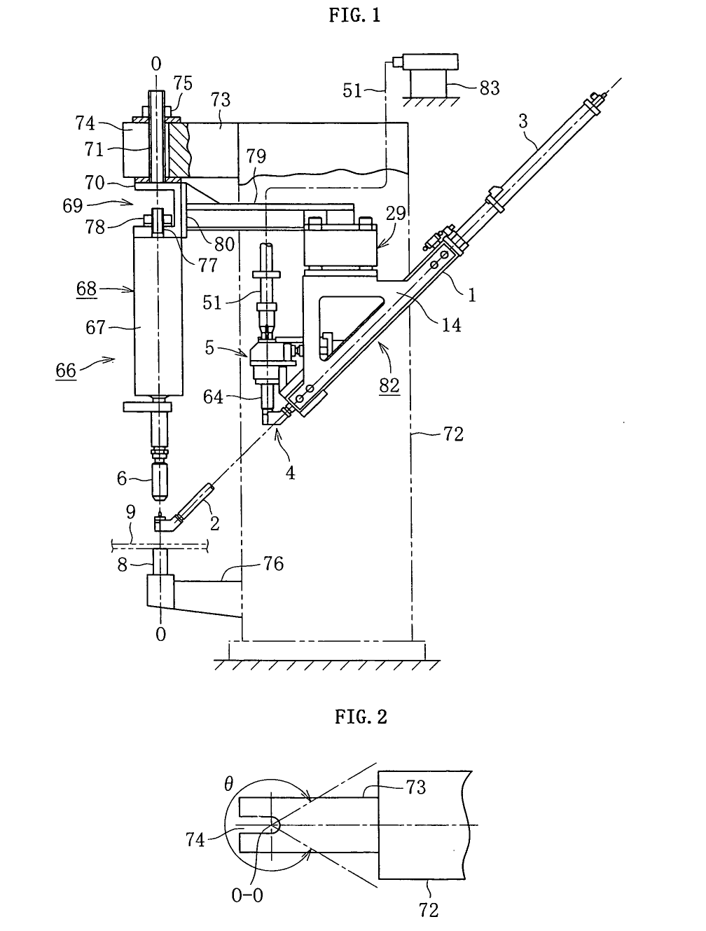

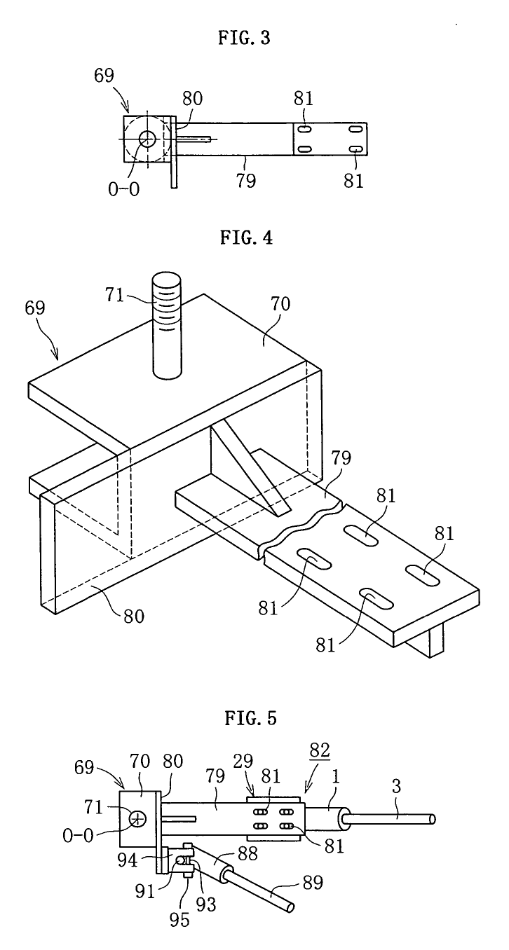

A first embodiment shown in FIGS. 1 to 4 will be first described.

In a welding device 66, a movable electrode 6 and a fixed electrode 8 are aligned in a moving axis line O-O of the movable electrode 6, and moving drive means 68 composed of an air cylinder 67 moves the movable electrode 6 forward and backward. A fixing member 69 is coupled to a top end of the air cylinder 67. The fixing member 69 is composed of a member main body 70 in the shape of the square U in cross section, and a fixed shaft member 71 integrated with the member main body 70. The operational axis line of the movable electrode 6, the axis line of the air cylinder 67, and the axis line of the fixed shaft member 71 are coaxially disposed with respect to the foregoing moving axis line O-O.

A support arm 73 being a stationary member is coupled to a top portion of a pole 72 of the welding device 66. An attachment groove 74 penetrating in a vertical direction is formed in the support arm 73. The fixed shaft member 71 is inserted into the attachment groove 74. An external thread is formed in the fixed shaft member 71, and the welding device 66 is attached on the stationary member by screwing a nut 75 onto the external thread. The fixed electrode 8, on the other hand, is coupled to a fixed arm 76 projecting from the pole 72. A bolt 77 is coupled to a top portion of the air cylinder 67. The bolt 77 penetrates the member main body 70, and a nut 78 is screwed onto the bolt 77.

Combining each part as described above, the welding device 66 comprising the air cylinder 67, the movable electrode 6, the fixed electrode 8, and the like which are aligned in the moving axis line O-O is disposed approximately in the vertical direction.

A long coupling member 79 is coupled to the rear face of the member main body 70 of the fixing member 69. In this embodiment, the coupling member 79 is coupled to the fixing member 69 by welding through an auxiliary member 80 described later. Four elliptic holes 81 are formed in the coupling member 79. Coupling bolts (not illustrated) penetrate through the elliptic holes 81 to couple a part feeding device 82 to the coupling member 79. Accordingly, the welding device 66 and the part feeding device 82 are integrated through the fixing member 69 and the coupling member 79.

The part feeding device 82 has a feeding rod 2 moving forward and backward. The size and shape of the coupling member 79, fixing member 69, and the like are set so that an end position of the feeding rod 2 and an end portion of the movable electrode 6 or fixed electrode 8 are in a predetermined relative positional relation, when the feeding rod 2 is moved forward.

When loosening the nut 75, the whole welding system into which the welding device 66 and the part feeding device 82 are integrated is rotatable with respect to the moving axis line O-O. The range of a rotation angle θ is shown in FIG. 2. The part feeding device 82 is rotated in this angle range, and the nut 75 is fastened in the position of not interfering with an adjacent related member to fix the welding system.

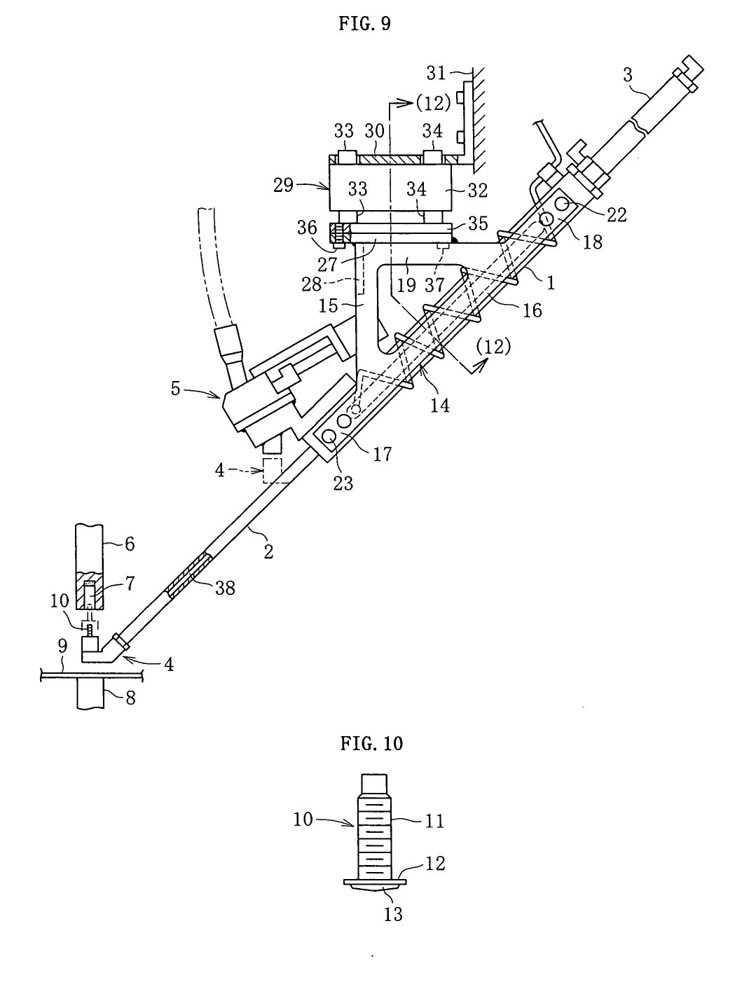

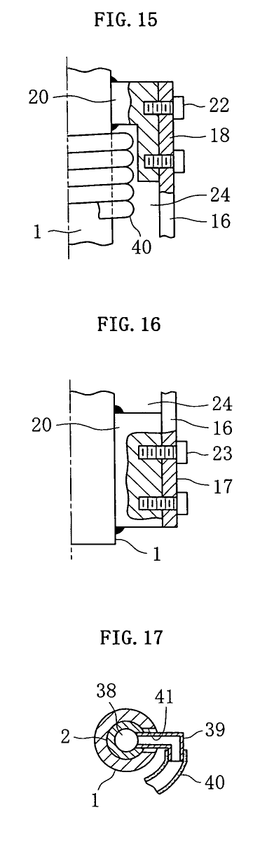

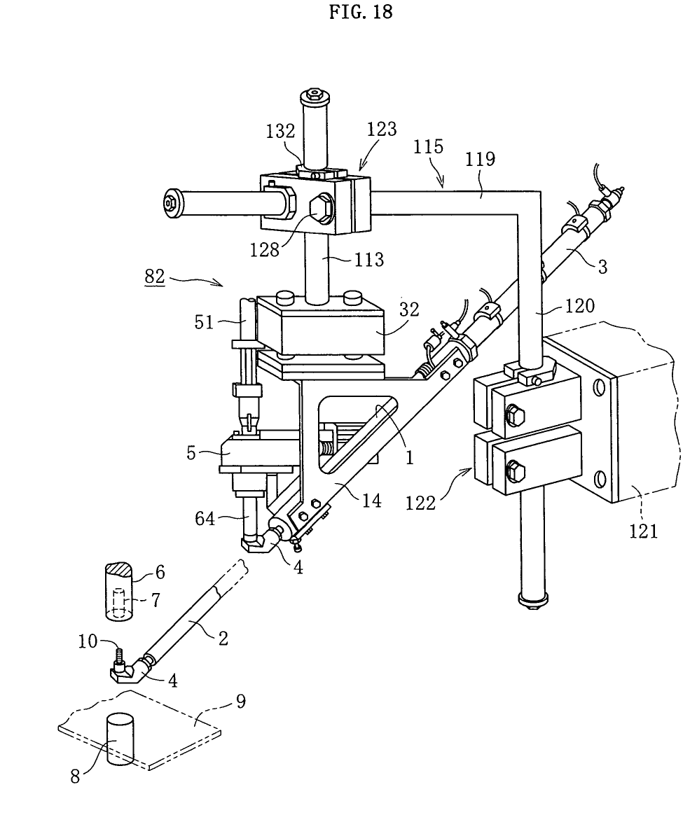

Part feeding devices 82 with various types of detailed structure are available, but the part feeding device 82 shown in FIGS. 9 to 17 will be described in this embodiment.

The feeding rod 2 is contained in a guide tube 1 movably forward and backward. A piston rod (not illustrate) of an air cylinder 3 coupled to an end of the guide tube 1 is coupled to the feeding rod 2. A hold member 4 for temporarily holding a part is coupled to an end of the feeding rod 2. When the hold member 4 is in the most backward position, as shown by chain double-dashed lines in FIG. 9, a part is fed to the hold member 4. This is because of feeding the part to the hold member 4 one by one, and a part feeding control unit (hereinafter simply called unit) represented by a reference number 5 performs such a function. This unit 5 is coupled to the side of the other end of the guide tube 1 opposite to the air cylinder 3.

In this embodiment, the part is inserted into an acceptance hole 7 of the movable electrode 6. A steel plate member 9 is mounted on the fixed electrode 8. The part is an iron projection bolt 10 shown in FIG. 10 in this embodiment. The projection bolt 10 comprises a transport section 11, a flange 12, and a projection 13 for welding. The projection 13 is formed by protruding the flange. The projection 13 is in the shape of an extremely flat cone, but a plurality of (three in general) warty projections may be provided instead.

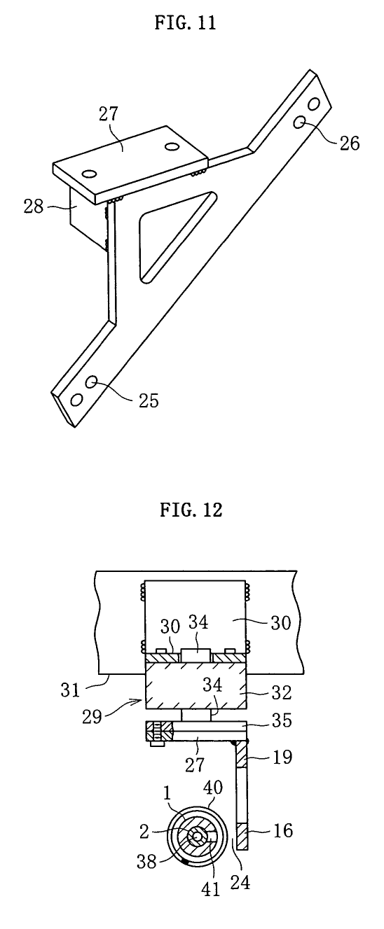

A base plate 14 is adopted to support integrated structure of the guide tube 1, the feeding rod 2, the air cylinder 3, the unit 5, and the like. The base plate 14 according to this embodiment mainly comprises a triangular section 15 which is in the shape of an approximately right triangle. The guide tube 1 is coupled to a bottom side section 16 of the triangular section 15. To further stably support the guide tube 1, the bottom side section 16 is provided with extended sections 17 and 18 as shown in FIGS. 9 and 11, and the bottom side section includes the extended sections 17 and 18. Since the feeding rod 2 is disposed in an inclined position, the bottom side section 16 is disposed in an inclined position, and the guide tube 1 is disposed on the periphery of the bottom side section 16. Spacers 20 and 21 are disposed between the guide tube 1 and the bottom side section 16, and each of the spacers 20 and 21 is welded to the guide tube 1. The bottom side section 16 is coupled to the spacers 20 and 21 with bolts 22 and 23. Accordingly, a clearance 24 is formed between the guide tube 1 and the bottom side section 16. Referring to FIG. 11, reference numbers 25 and 26 represent holes through which the foregoing bolts 22 and 23 penetrate.

A receiving plate 27 is welded to a top side section 19 of the base plate 14. To increase the rigidity of this portion, a reinforcing plate 28 is welded to the triangular section 15 and the receiving plate 27. The bottom face of an air cylinder 29 is coupled to the receiving plate 27, and the top face of the air cylinder 29 is tightly coupled to a stationary member 31 through a bracket 30. In this air cylinder 29, a cylinder 32 is coupled to the stationary member 31 through the bracket 30, and pistons (not illustrated), namely piston rods 33 and 34 move to output power. As shown in the drawing, the air cylinder 29 is in a tandem type with the two pistons. Bottom ends of both of the piston rods 33 and 34 are coupled to an output plate 35. The output plate 35 making tightly contact with the receiving plate 27 is fixed on the receiving plate 27 with bolts 36 and 37. The air cylinder 29 is fixed on the top side section 19 of the base plate 14, as described above, so that the piston rods 33 and 34 are disposed in the vertical direction.

The bracket 30 corresponds to the foregoing coupling member 79, and the stationary member 31 corresponds to the fixing member 69 and the support arm 73.

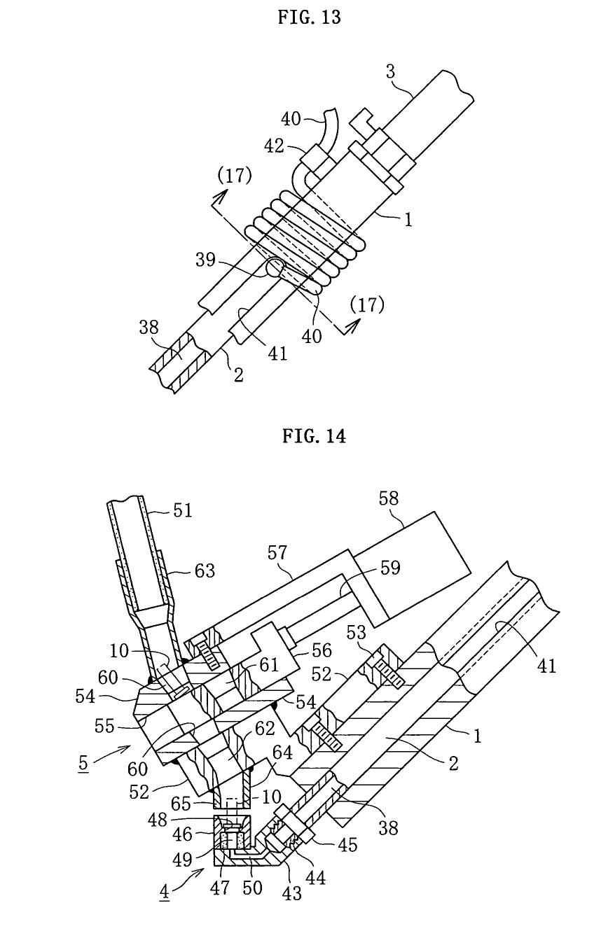

As is apparent from FIGS. 9, 13, 17, and the like, the feeding rod 2 is provided with an air passage 38. To feed air into the air passage 38, a joint 39 is screwed into the feeding rod 2, and an air hose 40 is connected to the joint 39. An elliptic hole 41 is formed in the guide tube 1 in an axial direction. The elliptic hole 41, through which the joint 39 passes, makes a stroke of the joint 39 possible. The air hose 40 is disposed in the foregoing clearance 24. The air hose 40 is spirally wound around the guide tube 1. When the feeding rod 2 moves forward, the air hose 40 changes from a shrinking state as shown in FIG. 13 to an elongated state as shown in FIG. 9. In FIG. 13, a reference number 42 refers to a clamp for fixing the air hose 40 to the guide tube 1.

The hold member 4 fixed at the end of the feeding rod 2 will be described mainly with reference to FIG. 14. The end of the feeding rod 2 is screwed into a main body 43 in a screw section 44, and a lock nut 45 locks the screw section 44 to prevent loosening. A cylindrical guide member 46 is fixed to an end of the main body 43 by welding or the like, and a ring-shaped magnet 47 is contained in the guide member 46. A flange 48 formed on the inner periphery of the guide member 46 is provided over the magnet 47. The flange 48 temporarily secures the projection bolt 10 in such a state that the flange 12 of the projection bolt 10 is attracted to the magnet 47. A penetration hole inside the magnet 47 becomes an air outlet 49. An air passage 50 formed through the main body 43 is connected to the air outlet 49 on the one hand, and is connected to the air passage 38 of the feeding rod on the other hand.

The part feeding control unit 5 has the function of feeding a part from a part feeding hose 51 connected to a part feeder 83 (see FIG. 1) to the hold member 4 one by one. FIG. 14 shows an embodiment of the part feeding control unit 5 in detail. Explaining the unit 5 on the basis of this drawing, the unit 5 is attached to an end of the guide tube 1 on the opposite side of the air cylinder 3. A bracket 52 is tightly fixed on the guide tube 1 with bolts 53, and a head member 54 is welded to the bracket 52. A through hole 55 in the shape of a rectangle in cross section is formed in the head member 54, and a control piece 56 is slidably inserted into the hole 55. An arm piece 57 is fixed on the top face of the head member 54. An air cylinder 58 is attached to the arm piece 57, and a piston rod 59 of the air cylinder 58 is coupled to the control piece 56.

Through holes 60, 61, and 62 are formed in the head member 54, the control piece 56, and the bracket 52, respectively. A joint tube 63 connected to the through hole 60 is welded to the head member 54, and the part feeding hose 51 is inserted into the joint tube 63. An outlet tube 64 connected to the through hole 62 is welded to the bracket 52. In a state shown in the drawing, the control piece 56 is misaligned, so that the bolt 10 is caught by the control piece 56. When the control piece 56 slides in a bottom left direction by the operation of the air cylinder 58 and the through holes 60, 61, and 62 are aligned for communication, however, the bolt 10 reaches the outlet tube 64 through the through holes, and reaches the guide member 46. A notch 65 is formed in the outlet tube 64 to pass the bolt 10 when the feeding rod 2 moves forward. Furthermore, when the hold member 4 is in the most backward position, the outlet tube 64 and the guide member 46 are in such a relative position that the outlet tube 64 is connected to the guide member 46 with leaving a slight clearance as shown in FIG. 14.

In the foregoing description, air hoses connected to each air cylinder are not illustrated. Furthermore, sequence control can easily control operation air to each air cylinder necessary for obtaining operation described below, by a combination of conventional means such as an electromagnetic air control valve, an electric control circuit, and the like. Thus, the detailed description thereof is omitted.

The operation of the first embodiment will be described. When the hold member 4 receives the bolt 10 in the state of FIG. 14, the feeding rod 2 moves forward by the operation of the air cylinder 3. At this time, the air hose 40 is elongated and takes a spiral shape as shown in FIG. 9. The movement of the feeding rod 2 is stopped in a position where the bolt 10 is coaxial with the acceptance hole 7, and then the base plate 14 is raised by the operation of the air cylinder 29, so that a part of the bolt 10 is inserted into the acceptance hole 7. Since air is jetted from the air outlet 49 at that time, the bolt 10 adsorbed by the magnet 47 is forcefully inserted into the farthest recess of the acceptance hole 7. After that, the feeding rod 2 moves oppositely to the former operation, to return to the original position as shown in FIG. 14. The bolt 10 inserted as described above is attracted by a magnet 66 attached to the deep recess of the acceptance hole 7, in order to prevent the bolt 10 from dropping. The movable electrode 6 holding the bolt 10 moves down, and the projection 13 of the bolt is pressed against the steel plate member 9. Then, the projection 13 is welded by passing electric current through both of the electrodes.

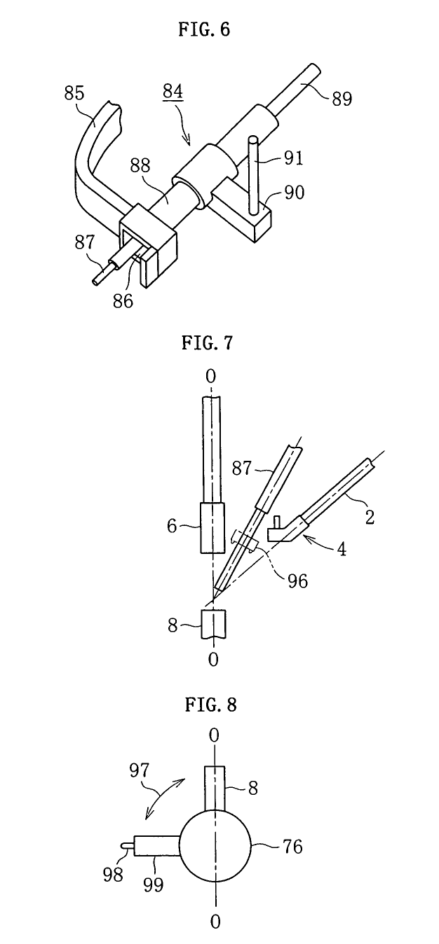

Next, a second embodiment will be described with reference to FIGS. 4 to 8.

In this embodiment, a plurality of part feeding devices for feeding different parts are provided. Each of the part feeding devices is attached to the foregoing coupling member or the auxiliary member integrated with the coupling member. The foregoing part feeding device 82 feeds the projection bolt 10 for welding, but a projection nut is additionally fed and welded in this embodiment. Thus, this embodiment is for the combined use of the projection bolt and the projection nut.

According to a part feeding device 84 for feeding the projection nut, the projection nut sent from a part feeder is guided to a temporary retaining chamber 86 through a part feeding tube 85, and temporarily retained therein. A feeding rod 87 penetrates a tapped hole of the temporarily retained projection nut in the state of a skewer, and then the feeding rod 87 moves forward to feed the projection nut to a target position. A guide tube 88 for containing the feeding rod 87, an air cylinder 89 for moving the feeding rod 87 forward and backward, and the like are identical to those of the former embodiment. FIG. 7 shows a projection nut 96 in a skewered state.

A bracket 90 is coupled to a guide tube 88, and a support rod 91 is fixed to the bracket 90. An auxiliary member 80 in the shape of a thick plate is welded to a member main body 70 of a fixing member 69 so as to protrude from a side of the member main body 70, and the part feeding device 84 is coupled to a protruding portion of the auxiliary member 80. A clamp piece 94 having a groove 93 in the shape of the letter U in cross section is coupled to the auxiliary member 80. The support rod 91 is inserted into the groove 93, and then a fixing bolt 95 penetrating the clamp piece 94 is clamped. FIG. 7 shows a state in which an end position of the feeding rod 87 moved forward and an end portion of a fixed electrode 8 (99, refer to FIG. 8) are in a predetermined relative positional relation. The relative positional relation is substantially equal if the relative position relation is set from the end portion of the fixed electrode 8, because the relative positional relation between the fixed electrode 8 and a movable electrode 6 is always unchanged when the movable electrode 6 is stopped. This is the same as in the feeding rod 2.

The attachment posture of the bracket 90 with respect to the guide tube 88, the rising direction of the support rod 91, the direction of the groove 93, and the like are determined so that the feeding rod 87 satisfies the positional relation shown in FIG. 7. In this embodiment, the clamp piece 94 is attached to the auxiliary member 92, but the clamp piece 94 may be directly fixed to the member main body 70 without the medium of the auxiliary member 92.

In FIG. 8, a fixed arm 76 is rotatable as shown by an arrow 97 in order to make fixed electrodes selectable. When the feeding rod 2 is operated, the rotational position of the fixed arm 76 is set so as to make the fixed electrode 8 corresponding to the feeding rod 2 coaxial with the movable electrode 6. When the feeding rod 87 is operated, the rotational position of the fixed arm 76 is set so as to make the fixed electrode 99 with a guide pin 98 corresponding to the feeding rod 87 coaxial with the movable electrode 6.

Therefore, according to the second embodiment, a plurality of part feeding devices 82 and 84 which can feed different types of parts are attached to the fixed member 69 or the auxiliary member 92 integrated with the fixed member 69. Thus, for example, the welding system can function as a welding unit of the projection nut, while functioning as a welding unit of the projection bolt, and hence it is possible to make the welding system multifunctional. It is possible to reduce space necessary for disposing equipment, and reduce the costs of the equipment.

The foregoing part is the projection bolt 10 with a flange which is provided with a projection for welding, and/or the foregoing projection nut 96 which is provided with a projection for welding. Accordingly, flexibly selected projection bolt 10 and projection nut 96 can be welded, and hence it is possible to obtain the welding system with high utility.

In the second embodiment, an electric motor may be used instead of the moving drive means 68 to perform forward and backward operation. An external thread may be formed over the whole length of the fixed shaft member 71, and a nut identical to the nut 75 may be disposed in the fixed shaft member 71 under the support arm 73, to arbitrarily obtain the relative position between the welding device 66 and the support arm 73 in a vertical direction by adjusting both of the upper and lower nuts. The position of the coupling member 79 may be minutely adjusted along the elliptic hole 81. Minute adjustment in two directions, as described above, makes it possible to easily obtain the appropriate relative position between the movable electrode 6 and the fixed electrode 8.

FIGS. 18 to 23 show a positioning device of the part feeding device. FIG. 18 shows the whole structure of the part feeding device 82. In this embodiment, the feeding rod 2, which moves forward and backward in an inclined direction, feeds the projection bolt 10 between the fixed electrode 8 and the movable electrode 6. An acceptance hole 7 is formed in the middle of the end face of the movable electrode 6, and the projection bolt 10 is inserted therein. A hold head 4 is provided in an end portion of the feeding rod 2, and the projection bolt 10 is held therein. A steel plate member 9 is mounted on the fixed electrode 8, and the projection bolt 10 is welded to the steel plate member 9 by projection welding.

The feeding rod 2 penetrates the inside of a support member 1 in the shape of a straight tube, movably forward and backward. An air cylinder 3 is connected to the support member 1, and the feeding rod 2 moves forward and backward by a stroke of the air cylinder 3. The support member 1 is fixed to a triangular bracket 14 with bolts or the like. An air cylinder 32 which outputs power in the vertical direction is attached on the bracket 14. A support rod 113 extending in the vertical direction is fixed on the top face of the air cylinder 32. The support rod 113 is coupled to a fixing bar 115 in a stationary state through a clamp block 123.

The feeding rod 2 moves forward, and stops in a position where the axis line of the projection bolt 10 becomes coaxial with the axis line of the fixed electrode 8 and the movable electrode 6. In this state, the projection bolt 10 is raised along the foregoing axis line, in order to insert the projection bolt 10 into the acceptance hole 7. To carry out such operation, the output direction of the air cylinder 32 is set to the same direction of the foregoing axis.

A feeding hose 51 extends from a part feeder (not illustrated) to feed the projection bolt 10 to the hold head 4 of the feeding rod 2. The feeding hose 51 is connected to a control unit 5 for passing the projection bolt 10 one by one, and the projection bolt 10 is provided from the control unit 5 to the hold head 4 moved backward through an outlet tube 64.

The fixing bar 115 which comprises a horizontal section 119 and a vertical section 120 takes the shape of the letter L. The vertical section 120 is coupled to a frame 121 being a stationary member. A coupling block 122 is adopted for this coupling. The coupling block 122, which can adjust the vertical position and direction of the fixing bar 115, has the function of making the fixing bar 115 in a stationary state.

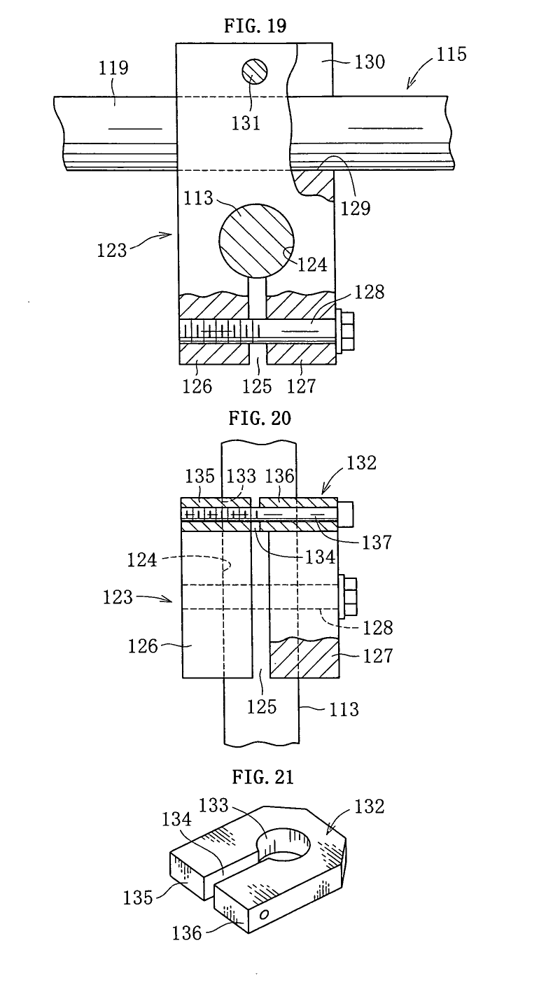

As shown in FIGS. 19 and 20, a penetration hole 124 passing in the vertical direction is formed in the clamp block 123 in the shape of an approximately rectangular parallelepiped, and a slit section 125 is formed so as to be connected to the penetration hole 124. The slit section 125 is formed by a clearance which is connected from one side of the outside of the clamp block 123 to the penetration hole 124. A fixing bolt 128 is screwed into squeeze sections 126 and 127 disposed on the right and left of the slit section 125 so as to penetrate the squeeze sections 126 and 127. An external thread section of the fixing bolt 128 is screwed into an internal thread section of the squeeze section 126.

The support rod 113 penetrates through the penetration hole 124. When the fixing bolt 128 is clamped, the inner peripheral surface of the penetration hole 124 makes tightly contact with the external peripheral surface of the support rod 113, so that the clamp block 123 is integrated with the support rod 113. When loosening the fixing bolt 128, the foregoing tight contact is released, and hence it becomes possible to slide the support rod 113 in the vertical direction.

The structure of integrating the clamp block 123 with the horizontal section 119 of the fixing bar 115 is the same as the foregoing structure of integrating the clamp block 123 with the support rod 113. A penetration hole 129 corresponds to the penetration hole 124. A slit section 130 corresponds to the slit section 125, and a fixing bolt 131 corresponds to the fixing bolt 128.

Referring to FIGS. 20 and 21, an auxiliary clamp block 132 is disposed over the clamp block 123. The auxiliary clamp block 132 made of a thick plate member has the same structure as the clamp block 123. In other words, a slit section 134 is formed so as to be connected to a penetration hole 133 through which the support rod 113 penetrates, and squeeze sections 135 and 136 are formed so as to sandwich the slit section 134. A fixing bolt 137 extends so as to penetrate the squeeze sections 135 and 136, and an external thread section of the fixing bolt 137 is screwed into an internal thread section of the squeeze section 135. The end face of the auxiliary clamp block 132 can abut to the end face of the clamp block 123.

FIG. 20 shows the case where the auxiliary clamp block 132 is disposed over the clamp block 123 to move down the part feeding device 82. To move up the part feeding device 82, the auxiliary clamp block 132 is disposed under the clamp block 123 as shown in FIG. 23. Instead of disposing the auxiliary clamp block 132 over or under the clamp block 123, as described above, the auxiliary clamp blocks 132 may be disposed on both sides of the clamp block 123.

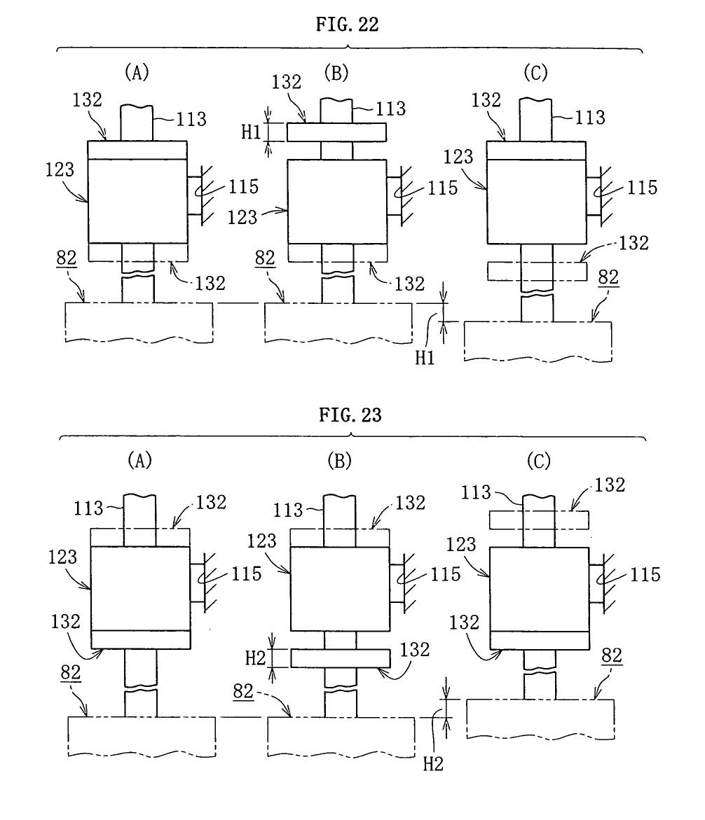

FIG. 22 shows the sequence of the operation of moving down the part feeding device 82. At first, the clamp block 123 is clamped on the support rod 113. Then, the auxiliary clamp block 132 over the clamp block 123 is loosened and moved up by a length H1, which corresponds to a distance to be moved down. Then, the auxiliary clamp block 132 is tightly clamped again on the support rod 113. After that, upon loosening the clamp block 123, the support rod 113 is moved down due to a mass of the part feeding device 82. The auxiliary clamp block 132 is caught by the top face of the clamp block 123 in the stationary state, and then the vertical position of the part feeding device 82 is set. The clamp block 123 is clamped at the last, so that move-down operation is completed.

The auxiliary clamp block 132 is moved upward in advance by the predetermined distance H1 in this manner, so that it is possible to set the amount H1 of moving down the part feeding device 82. Furthermore, the support rod 113 is moved down by its own weight of the part feeding device 82, and the auxiliary clamp block 132 functions as a stopper, so that the lower limit position of move-down is set. Accordingly, it is possible to precisely set the amount H1 of move-down with easy operation. Furthermore, the operation is simplified and becomes safe. When the auxiliary clamp block 132 is also disposed under the clamp block 123 as shown by chain double-dashed lines, the auxiliary clamp block 132 is moved up after the completion of the move-down operation. Then, the auxiliary clamp block 132 is made tightly contact with the bottom face of the clamp block 123, and is clamped on the support rod 113.

FIG. 23 shows the sequence of the operation of moving up the part feeding device 82. At first, the clamp block 123 is clamped. Then, the auxiliary clamp block 132 under the clamp block 123 is loosened and moved down by a distance H2, which corresponds to a distance to be moved up. Then, the auxiliary clamp block 132 is tightly clamped again on the support rod 113. After that, since the clamp block 123 is loosened and the part feeding device 82 is lifted up, the support rod 113 is moved up. The auxiliary clamp block 132 is caught by the bottom face of the clamp block 123 in the stationary state, and then the vertical position of the part feeding device 82 is set. The clamp block 123 is clamped at the last, so that move-up operation is completed.

As described above, the amount H2 of moving up the part feeding device 82 can be set only by moving down the auxiliary clamp block 132 by the predetermined distance H2 in advance. Furthermore, the support rod 113 can be moved up only by lifting the part feeding device 82. The auxiliary clamp block 132 functions as a stopper, so that the upper limit position of move-up is set. Accordingly, it is possible to precisely set the amount H2 of move-up with easy operation. Furthermore, the operation is simplified and becomes safe. When the auxiliary clamp block 132 is also disposed over the clamp block 123 as shown by chain double-dashed lines, the auxiliary clamp block 132 is moved down after the completion of the move-up operation. Then, the auxiliary clamp block 132 is made tightly contact with the top face of the clamp block 123, and is clamped on the support rod 113.

The structure of the foregoing clamp block and the auxiliary clamp block is available for adjusting the vertical position of the vertical section 120 in the position of the coupling block 122 shown in FIG. 18.

1. A welding system characterized in that a welding device in which a movable electrode is attached to moving drive means, the movable electrode and a fixed electrode forming a pair, and a part feeding device for feeding a part to a target position by a feeding rod moving forward and backward are integrated through a coupling member, so that an end position of the feeding rod moved forward and an end portion of the movable electrode or the fixed electrode are in a predetermined relative positional relation.

2. The welding system according to claim 1, wherein a fixing member for fixing the welding device on a stationary member is provided.

3. The welding system according to claim 2, wherein:
the fixing member comprises a member main body and a fixed shaft member, which are integrated with each other;
the member body is coupled to an end portion of the moving drive means;
the fixed shaft member is coupled to the stationary member to fix the welding system on the stationary member;
an axis line of the fixed shaft member is approximately coaxial with a moving axis line of the movable electrode; and
a rotational position of the welding system can selectively be set by rotating the member main body with respect to the fixed shaft member.

4. The welding system according to claim 2, wherein the coupling member is integrated with the fixing member.

5. The welding system according to claim 1, wherein a plurality of part feeding devices each of which feeds a different type of part are attached to the coupling member or an auxiliary member integrated with the coupling member.

6. The welding system according to claim 1, wherein the part is a projection bolt with a flange which is provided with a projection for welding.

7. The welding system according to claim 1, wherein the part is a projection nut provided with a projection for welding.

8. The welding system according to claim 1, wherein a support rod which is attached to the part feeding device and extends approximately in a vertical direction penetrates a clamp block fixed on the stationary member and the clamp block clamps and loosens the outer periphery of the support rod to set the vertical position of the support rod, and an auxiliary clamp block for setting a moving distance of the support rod in advance is disposed over or under the clamp block in such a manner that the auxiliary clamp block penetrates the support rod.

9. The welding system according to claim 8, wherein the clamp block has a penetration hole through which the support rod with a circular cross section penetrates, a slit section continued from the penetration hold, and a fixing bolt penetrating the slit section.

10. The welding system according to claim 8, wherein: the auxiliary clamp block has a penetration hole through which the support rod penetrates, a slit section continued from the penetration hole, and a fixing bolt penetrating the slit section; and an end face of the auxiliary clamp block can abut to an end face of the clamp block.

11. The welding system according to claim 8, wherein the part feeding device is a device that feeds a part held by the feeding rod to the fixed electrode or the movable electrode of the welding device, in order to weld the part fed between the fixed electrode and the movable electrode by the feeding rod to the target part.

12. A positioning device of a part feeding device wherein a support rod which is attached to the part feeding device and extends approximately in a vertical direction penetrates a clamp block fixed on a stationary member and the clamp block clamps and loosens the outer periphery of the support rod to set the vertical position of the support rod, characterized in that an auxiliary clamp block for setting a moving distance of the support rod in advance is disposed over or under the clamp block in such a manner that the auxiliary clamp block penetrates the support rod.

13. The positioning device of the part feeding device according to claim 12, wherein the clamp block has a penetration hold through which the support rod with a circular cross section penetrates, a slit section continued from the penetration hole, and a fixing bolt penetrating the slit section.

14. The positioning device of the part feeding device according to claim 12, wherein:
the auxiliary clamp block has a penetration hole through which the support rod penetrates, a slit section continued from the penetration hole, and a fixing bolt penetrating the slit section; and an end face of the auxiliary clamp block can abut to an end face of the clamp block.

15. The positioning device of the part feeding device according to claim 12, wherein the part feeding device is a device that feeds a part held by the feeding rod to the fixed electrode or the movable electrode of the welding device, in order to weld the part fed between the fixed electrode and the movable electrode by the feeding rod to the target part.
